(19) United States
(12) Patent Application Publication
(10) Pub. No.: US 2019/0318656 A1
(43) Pub. Date: Oct. 17, 2019

(54) INFORMATION PROCESSING DEVICE, METHOD FOR CONTROLLING SAME, AND COMPUTER PROGRAM

(71) Applicant: Akitoshi KOJIMA, Tochigi (JP)

(72) Inventor: Akitoshi KOJIMA, Tochigi (JP)

(21) Appl. No.: 16/302,726

(22) PCT Filed: May 19, 2017
(86) PCT No.: PCT/JP2017/018928

§ 371 Date: Jan. 11, 2019

(30) Foreign Application Priority Data
May 19, 2016 (JP) 2016-100157

(51) Int. Cl. G09B 19/06; G06F 17/27; G09B 7/04

(52) U.S. Cl. CPC G09B 19/06; G09B 7/04; G06F 17/2735

(57) ABSTRACT

To provide an information processing device capable of freely selecting content for language study according to the learning level and learning style of a learner. An information processing device 100 for outputting, as a learning content, content created in the language to be learned extracts, for each content, vocabulary used in one or each of a plurality of contents and comprising words, idioms or phrases in the language to be learned, wherein each of the phrases comprise a plurality of words. The information processing device 100 also records, as recognized words, the vocabulary learned by the learner. Further, the information processing device 100 specifies, based on the extraction result and the recorded recognized words, the level of understanding of content of the learner as a recognized word rate of content. The information processing device 100 presents the specified recognized word rate of content to the learner, and performs control such that content selected based on the presented recognized word rate of content is output as the learning content.

### FIELD OF THE INVENTION

The present invention relates to a technology for an information processing device that supports effective learning according to the language level of a learner.

### BACKGROUND OF THE INVENTION

It has been said that language study is the most effective when a learner is exposed to a language to be learned on a daily basis. There is an English learning method in which the reading comprehension of English sentences is enhanced by reading many English sentences as a language to be learned. The popularization of the Internet allows people to have easy access to many English sentences. There are also learning methods for allowing a learner to view and listen to content such as movies and music created in a language to be learned.

However, vocabulary used in content such as movies and music including words, idioms and unique expressions (phrases) varies depending on the category of the content such as horror movies and action movies in the case of movies. As such, the problem is that it is difficult to select content suitable for learning, from among interesting categories, based on the knowledge level (learning level) of an individual user (learner) in a language to be learned.

In response to such a problem, a language learning device disclosed in Patent Literature 1 (Japanese Patent Application Kokai Publication No. H01-29889) determines learning content based on one video learning material selected by a student from among a group of presented video learning materials and also based on the learning history of the student. Then, instructions for learning are given to the student based on the information about the content of learning materials specified by the determined learning content. As a result, the student can select an interesting video learning material from among a plurality of presented video learning materials to learn content that matches the learning history of the student.

A content distribution system disclosed in Patent Literature 2 (Japanese Patent Application No. 2006-337490) makes existing content such as digital movie software available as a learning material without changing the content, so that learning effect can be enhanced with high efficiency.

Also, a determination device disclosed in Patent Literature 3 (Japanese Patent Application No. 2015-004756) can recommend learning content suitable for a user even when the content is phonetic.

### SUMMARY OF THE INVENTION

There are various types of learning methods in language study, and a user (i.e., a learner) wants to select a learning style suitable for him/her depending on his/her feeling at a specific time. For example, learning a language by just listening (i.e., learning a language through ears) is a simple way of learning. Also, a user might want to learn a language carefully using content of the level higher than his/her own level in order to test the level of his/her understanding of the language. Alternatively, a user might want to designate the content of a genre that is suitable for his/her feeling at a specific time (e.g., a general journal, an economic journal, a horror movie, or an action movie).

As disclosed in Patent Literatures 1 through 3, there are some conventional systems that provide learning content based on the learning level of a user. However, the problem is that not only the learning efficiency is kept low but a user feels stressed as well, because the learning option of content is limited and the language study is very passive.

If the content is presented based on the learning level of an individual user, it is not easy for the user to know the level of difficulty of the content. Thus, the problem still remains that the user cannot freely change his/her learning style according to his/her feeling at a specific time.

Moreover, a user is not just limited in the option of selecting content but might also receive content recommendation at the timing unsuitable for conducting language study with high efficiency.

The present invention is mainly to provide an information processing device capable of freely selecting content for language study according to the learning level and learning style of a learner. The information processing device also recommends content to be learned at the timing suitable for conducting language study with high efficiency.

The present invention relates to an information processing device for outputting a content created in a language to be learned as a learning content, the device comprising: an extraction unit for extracting, for each content, vocabulary used in one or each of a plurality of contents and comprising words, idioms or phrases in the language to be learned, wherein each of the phrases comprise a plurality of words; a recording unit for recording vocabulary learned by a learner as first information; a specification unit for specifying the level of understanding of content of the learner as second information based on the extraction result obtained by the extraction unit and the first information recorded by the recording unit; a presentation unit for presenting the specified second information to the learner; and a control unit for performing control such that the a selected content based on the presented second information is output as the learning content.

### Effect of the Invention

According to the present invention, content for performing language study can freely be selected according to the learning level and learning style of a learner.

### BRIEF DESCRIPTION OF THE DRAWINGS

FIG. 1 is a view showing one example of the functional composition of an information processing device.

FIG. 2 is a view showing one example of vocabulary stored in a dictionary DB in a language to be learned.

FIG. 3 is a view showing one example of learning vocabulary stored in the storage unit.

FIG. 4A and FIG. 4B are views showing one example of learning histories recorded in the user recording unit.

FIG. 5 is a view showing one example of recognized word rates of content recorded in the user skill recording unit.

FIG. 6 is a flowchart showing one example of processing procedures by an information processing device.

FIG. 7 is a flowchart showing one example of processing procedures in which a recognized word rate of content is specified and displayed on a display screen.

FIG. 8 is a schematic view of an exemplary screen display when information about a recognized word rate of content is presented to a learner.

FIGS. 9A, 9B, and 9C are schematic views of an exemplary screen display when information used for confirming learning effects is presented to a learner.

FIGS. 10A, 10B and 10C are schematic views of an exemplary screen display when information about recommended content is presented to a learner.

FIG. 11 is a view showing an exemplary composition of an information processing device when it is linked to a mobile information terminal.

### DETAILED DESCRIPTION OF THE INVENTION

The following describes embodiments with reference to drawings. The present embodiment describes an example of extracting vocabulary containing words, idioms or phrases in a language to be learned from a content-recorded medium such as movies and music created in the language to be learned such as English and French. In other embodiments, characters recorded in a paper medium such as a book and a journal can be extracted by scanning those characters and converting them into text information.

As used in the present embodiment, the term “phrase” refers to a group of words such as an idiom and a set phrase or expression. The abovementioned language to be learned such as English and French are only examples. The invention is not limited to those examples. In English, for example, there are some differences in pronunciation (or accent, dialect, etc.) between British English and American English depending on content. A user (i.e., a learner) can select content for learning (learning content) from among a plurality types of content in light of the abovementioned points.

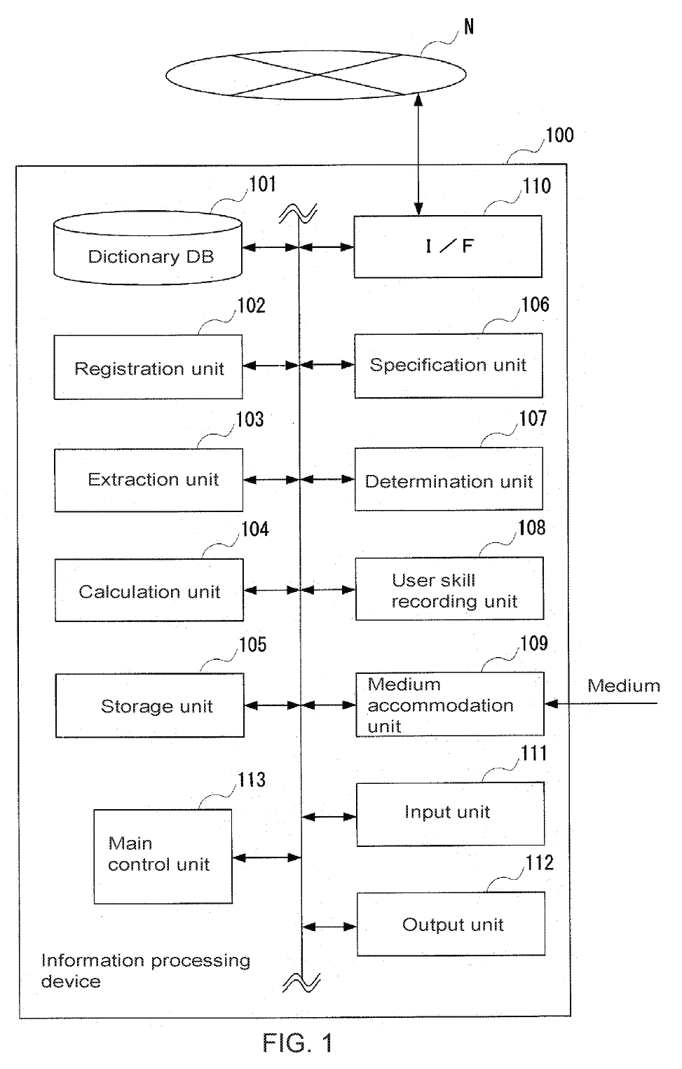

FIG. 1 is a view showing one example of the functional composition of an information processing device according to the present embodiment.

In the present embodiment, an information processing device 100 is a device provided with an information processing function such as personal computer, tablet PC and smartphone and has a function of outputting a content created in a language to be learned as a learning content.

The information processing device 100 is constituted of a dictionary DB (database) 101, a registration unit 102, an extraction unit 103, a calculation unit 104, a storage unit 105, a specification unit 106, a determination unit 107, a user skill recording unit 108, a medium accommodation unit 109, an 1/F (interface) 110, an input unit 111, an output unit 112, and a main control unit 113. The following describes each functional composition thereof in detail.

The dictionary DB 101 stores vocabulary containing words, idioms or phrases in a language to be learned after associating it with the level of difficulty in learning (which shows the level of each learning difficulty). For example, dictionary data about one or a plurality of widely-used languages to be learned is stored in the dictionary DB 101. The dictionary data includes data created for each learning target (e.g., middle school students, travelers, businessmen).

The level of learning difficulty is represented by five stages (1 to 5), for example, in which the level of difficulty is 2 if the learning target is a middle school student, and it is 4 if the learning target is a businessman. In dictionary data created for beginners, middle-class learners and advanced learners, the level of difficulty of content for beginners is classified as 1, the level of difficulty between content for beginners and content for middle-class learners is classified as 3, and the level of difficulty between content for beginners and middle-class learners and content for advanced learners is classified as 5. In this case the level of learning difficulty is represented by three stages.

When multiple types of dictionary data is stored in the dictionary DB 101 and vocabulary is overlapped among those multiple types of dictionary data, a lower level of learning difficulty should preferentially be associated first. Thus, the dictionary DB 101 serves as a means for recording dictionary data. In the case of dictionary data for travelers, for example, the level of learning difficulty may be decided according to the order of vocabularies that should preferentially be learned.

The registration unit 102 registers the level of learning of a learner, shows the status of learning in a language to be learned (user skill), in the user skill recording unit 108, as described below. This learning level corresponds to the level of difficulty in learning vocabulary in a language to be learned. By way of example, the learning level may be represented by five stages (1 to 5) in order to match the level of learning difficulty in a language to be learned stored in the dictionary DB 101 or represented by three stages, i.e., beginners, middle-class learners and advanced learners. The user skill recording unit 108 may register a learning level assessed by a learner or register a learning level determined by a learning evaluator (e.g., a teacher).

The learning level of a learner may automatically be changed (updated) on the basis of any learning effect via the registration unit 102 after the first registration of learning, as described in detail below.

The registration unit 102 stores specific vocabulary in a language to be learned and the level of difficulty in learning the vocabulary in the dictionary DB 101 according to instructions given by a learner. For example, characteristic phrases, etc. in a category desired by a learner can individually be stored in the dictionary DB 101 via the registration unit 102. A learner can delete vocabulary stored in the dictionary DB 101 via the registration unit 102. Thus, the maintenance of the dictionary DB 101 can be achieved.

In this manner, the registration unit 102 serves as a registration unit for registering the learning status of a learner in a language to be learned as a learning level.

The extraction unit 103 extracts, for each content, vocabulary used therein in a language to be learned. Vocabulary may be extracted in the form of comparability with vocabulary stored in the dictionary DB 101 and may also be each extracted for “word,” “idiom” or “phrase.”

By way of example, with regard to frequently-used words such as “a” or “for,” extraction conditions may be established in advance such that those words can be extracted only when they are contained in “phrases.” Accordingly, not only time required for extraction can be shortened, but storage area of memory used at the time of extraction processing can be reduced as well.

The extraction unit 103 also extracts timing when vocabulary to be learned (learning vocabulary), which is specified by the specification unit 106, as described below, from the extracted vocabulary, is used in content as output timing. When the phrase “get under way” used in a movie is learning vocabulary, for example, the start of reproduction (output) of this movie is the starting point, and the learning vocabulary “get under way” is time information showing the starting point of an output.

For example, if the phrase “get under way” is used in the movie multiple times, output timing is extracted for as many as the number of uses. Alternatively, output timing may be represented as time information covering the point of time when the output of the phrase “get under way” is started and the point of time when the output is ended.

Thus, the extraction unit 103 serves as an extraction unit for extracting, for each content, vocabulary containing words, idioms or phrases comprising a plurality of those words in a language to be learned, which is used in one or each of a plurality of types of content.

The calculation unit 104 calculates frequency in which extracted vocabulary is each used in content (frequency in use). More specifically, it calculates the number of extractions for vocabulary (the number of uses) on the basis of extraction results obtained by the extraction unit 103. Vocabulary with a high frequency in use is a vocabulary which a learner should know in comprehending content.

For example, if the category of content is the field of horror movies, the vocabulary might be phrases characteristic of the field, while it might be vocabulary expressing the name of a country, the name of a city or the like, if the category is the field of traveling. Vocabulary with a high frequency in use within content is a vocabulary that is output with a high frequency when a learner listens to the content and, therefore, helps enhance learning efficiency.

Thus, the calculation unit 104 serves as a calculation unit for calculating the number of uses of vocabulary in a language to be learned used in content as the frequency in use.

The storage unit 105 is, for example, a memory device such as flash memory and hard disk. The storage unit 105 stores learning vocabulary specified by the specification unit 106, as described below, and the output timing of respective learning vocabulary after associating them with each other. Also, the storage unit 105 stores extraction results obtained by the extraction unit 103 by extracting, for each content, vocabulary in an language to be learned used therein after associating those results with the content.

Thus, the storage unit 105 serves as a storage unit for establishing the timing when specified learning vocabulary is used in content as output timing and storing the output timing and the learning vocabulary after associating them with each other.

The configuration may also be such that vocabulary specified from content, which a learner takes an interest, is stored in the storage unit 105. In this case, learning vocabulary stored in the storage unit 105 can be used as an original dictionary (personal dictionary file) of a learner in a specific category.

The specification unit 106 specifies learning vocabulary to be learned corresponding to a learning level from among vocabulary extracted from content in a language to be learned in decreasing order of frequency in use. Hence, learning vocabulary specified according to the learning level of a learner is also unique. Learning vocabulary may be specified in decreasing order of frequency in use, wherein 20 words are specified as the learning vocabulary, for example. Various conditions such as the number of specified words should be established in advance.

As other conditions for specifying learning vocabulary, only “words” may be specified, or “phrases” comprising “words” corresponding to learning levels may be specified. Accordingly, learning vocabulary according to the learning purpose of a learner can be specified.

Alternatively, the configuration may be such that after checking extracted vocabulary in an language to be learned against vocabulary stored in the dictionary DB 101 corresponding to the learning level of a learner, completely matched vocabulary may be specified, or vocabulary with the highest degree of coincidence (i.e., the highest likelihood) may be specified.

The specification unit 106 may also specify information showing the level of understanding, for each content, corresponding to each learner (second information; hereinafter referred to as a recognized word rate of content).

The recognized word rate of content is a value showing the percentage of vocabulary learned by a learner (first information; hereinafter referred to as recognized words) as compared with vocabulary extracted, for each content, by the extraction unit 103 in a language to be learned used therein (hereinafter referred to as words used in content).

The recognized word rate of content changes in its value on the basis of the learning level, which in turn changes according to recognized words and the learning history of a learner. If learning content changes, the value of the recognized word rate of content also changes accordingly, even when there is no change in the recognized words of a learner. This is because vocabulary used is different even when the content belongs to the same genre.

The setting may be such that words used in content is weighed according to the frequency in use of vocabulary calculated by the calculation unit 104, and that if a learner understands vocabulary in content with a high frequency in use, the recognized word rate of content specified by the specification unit 106 increases accordingly.

Thus, the specification unit 106 serves as a specification unit for specifying the level of understanding of content of a learner (second information) based on the extraction result obtained by the extraction unit 103 and recognized words recorded in the user skill recording unit 108 as described below (first information).

Recognized words for each learner are specified, for example, on the basis of the determination result obtained by the determination unit 107, and the specified recognized words are recorded, for each learner, in the user skill recording unit 108. The recognized word rate of content specified for each content is recorded in the user skill recording unit 108 after it is associated with a learner, content to be used, etc. The following describes one exemplary method for registering recognized words.

In the information processing device 100 according to the present embodiment, the configuration may be such that recognized words registered via the specification unit 106 may be recorded as a vocabulary that has been learned (understood) by a learner using a wide variety of methods.

For example, when a learner is performing reading learning using learning content displayed on the display screen and comes across an unknown vocabulary, the learner taps the unknown vocabulary on the screen, so that the tapped vocabulary is distinguishably controlled as an unclear vocabulary, i.e., a vocabulary that is unknown to the learner (i.e., the learner has not learned yet). Vocabularies other than the vocabulary identified as an unclear vocabulary in the entire vocabularies contained in the learning content is identified as vocabularies understood by the learner, and therefore control can be performed such that those vocabularies are registered as recognized words. In this manner, recognized words of a learner can be registered.

The configuration may also be such that recognized words of a learner are specified by using dictionary data stored in the dictionary DB 101 and then registered, for example. More specifically, vocabulary contained in given dictionary data is displayed in whole or in part on the display screen, a learner checks vocabulary that he/she understands from among the displayed vocabulary, and then control is performed such that the checked vocabulary is registered as recognized words. In this manner, recognized words of a learner can be registered.

Alternatively, the configuration may also be such that vocabulary contained in given dictionary data is displayed in whole or in part on the display screen, a learner checks a vocabulary that he/she is unknown from among the displayed vocabulary, and then vocabularies other than the checked vocabulary are registered as the recognized words of a learner.

Furthermore, the configuration may also be such that a vocabulary understood by a learner is assumed on the basis of results obtained by the learner who used other language study systems, using a system equipped with so-called AI (Artificial Intelligence, and then recognized words are specified and recorded on the basis of those assumed results.

As we return to the explanation of FIG. 1, the determination unit 107 determines whether or not the acceptance timing of input operation accepted while content has been output and the output timing of learning vocabulary have occurred at the same timing.

More specifically, when input operation was accepted while a certain learning vocabulary in content was output (e.g., a learning vocabulary “get under way” was output phonetically), the determination unit 107 determines that the timing is the same. Or, the configuration may also be such that when input operation was accepted after the output of the learning vocabulary “get under way” ended and before a first predetermined time (e.g., two seconds) had passed, the unit determines that the timing is the same. Alternatively, the configuration may also be such that when input operation was accepted during a period between a point of time when the output of the learning vocabulary “get under way” was started and a point of time when a second predetermined time (e.g., five seconds) had passed, the unit determines that the timing is the same.

Thus, the determination unit 107 serves as a determination unit for determining whether or not the output timing of learning vocabulary and the acceptance timing of input operation occurs at the same timing.

Learning vocabulary determined by the determination unit 107 that the timing was the same is recorded in the user skill recording unit 108 as recognized words understood by a learner.

The user skill recording unit 108 records the recognized words of a learner, the recognized word rate of content, the learning level accepted via the registration unit 102, the learning history containing information about content selected and viewed by the learner for learning and the like. Furthermore, the user skill recording unit 108 may also be configured such that the learning level can be recorded for each type such as words, idioms or phrases.

Thus, the user skill recording unit 108 serves as a recording unit for recording vocabulary learned by a learner as recognized words (first information).

The medium accommodation unit 109 readably stores a medium (e.g., DVD (Digital Versatile Disc), card-like recording medium) in which content has been recorded. Content recorded in a medium, which is in turn recorded in the medium accommodation unit 109, is readily readable according to instructions given by a learner and then output to the output unit 112 as described below. In this manner, the learner can view content such as movies and music.

The I/F 110 controls, for example, sending and receiving information via an Internet line N or sending and receiving information via wireless communication. Or, a learner may give instructions to download content stored in a server device (not shown here), which is connected to the Internet line N, via the I/F 110, and then view the downloaded content.

The input unit 111 is an input device such as a keyboard and a pointing device and accepts input operation of a learner. Thus, the input unit 111 serves as an acceptance unit for accepting input operation.

The output unit 112 is, for example, a display device that displays videos and subtitles recorded in content, a speaker that outputs voices, and the like. The output unit 112 displays learning vocabulary specified on the display screen of a display device as characters or outputs voices from a speaker.

The output unit 112 also displays the determination results obtained by the determination unit 107 on the screen. Thus, the output unit 112 serves as a presentation unit for presenting various types of information to a learner.

The following description is given on the assumption that a learner starts viewing content only after watching or listening to output learning vocabulary for learning.

The main control unit 113 controls various component devices of the information processing device 100. The main control unit can be operated by collaboration between the hardware resource of a computer device containing a processor and an internal memory, which are contained in the information processing device 100, and predetermined computer programs. The information processing device 100 comprises an RTC (Real Time Clock) module that outputs time data showing date, month and year and a synchronizing clock for control operation.

The following describes in detail the specification of correct answer rates, the determination of recommended content and the presentation of the same to a learner, the setting of a learning schedule, etc. mainly performed by the control unit 113.

The main control unit 113 performs control, for example, such that input operation accepted during the content output is recorded (stored) in a predetermined storage area of the storage unit 105 as input operation with respect to the output of learning vocabulary. More specifically, if the input unit 111 is a keyboard, it is recorded that the key was pressed by a learner. Thus, the control of the control unit 113 allows for comprehending the number of input operations performed by a learner during the content output, i.e., comprehending how many times the learner pressed the key.

The main control unit 113 also makes a comparison between the number of times of recording performed as input operation with respect to the output of learning vocabulary and the total number of learning vocabulary specified by the specification unit 106. As a result, the correct answer rate can be specified that is one of indicators showing learning effects in content viewed by a learner.

For example, supposing the number of words in learning vocabulary specified in content is 20 (exclusive of duplication), the total number of outputs including duplicated learning vocabulary is 50, and the number of input operations accepted during the content output is 25, the correct answer rate is 50(%). The registration unit 102 changes the learning level according to this correct answer rate.

In this case, the main control unit 113 performs control in such a way as to record input operation accepted during the content output as input operation with respect to the output of learning vocabulary, compare the number of outputs of learning vocabulary with the number of acceptances of input operation, make the learning vocabulary a vocabulary learned by a learner according to the comparison result, and record the vocabulary as recognized words (first information).

The configuration may also be such that when a key different from a pre-set key is pressed, the input operation is not recorded.

The main control unit 113 can also specify the correct answer rate for each learning vocabulary as one of indicators showing learning effects in content viewed by a learner.

In this case, the main control unit 113 performs controls in such a way as to record the acceptance timing of input operation, when the determination unit 107 determines that the acceptance timing of input operation and the output timing of the learning vocabulary has occurred at the same timing. Such control of the main control unit 113 allows for finding the correct answer rate of learning vocabulary by aggregating learning vocabulary corresponding to the recorded acceptance timing, on the basis of the output timing of learning vocabulary.

In this case, the main control unit 113 performs controls in such a way as to make the learning vocabulary a vocabulary learned by a learner when the determination unit 107 determines that the timing is the same, and records the vocabulary as recognized words (first information). That is, as described above, the learning vocabulary determined by the determination unit 107 that the timing is the same is recorded in the user skill recording unit 108 as recognized words learned (understood) by the learner.

The main control unit 113 can also specify the correct answer rate of a learner at predetermined timing sometime between the start of viewing content by the learner and the end of the same, as one of indicators showing learning effects in content viewed by the learner. In this case, the main control unit 113 changes the learning level according to the correct answer rate via the registration unit 102, even when content viewing is still in progress.

The main control unit 113 presents (recommends) information about another content comprising learning vocabulary having a higher level of difficulty in learning than the current content as recommended content, if the correct answer rate for each learning vocabulary has already exceeded a predetermined threshold value (e.g., the correct answer rate is 90(%)), even when content viewing is still in progress. Such control of the main control unit 113 allows a learner to change language study to one corresponding to the most-recent learning level without waiting for the end of viewing content, and therefore effective learning according to the progress of learning can be achieved.

The recommended content may be determined on the basis of the learning level recorded in the user skill recording unit 108, the recognized word rate of content, learning history comprising information about content selected and viewed by a learner for learning, learning vocabulary stored in the storage unit 105, and the like.

For example, if a learner is interested in a US movie, the recommended content may be configured to contain other movies of the same movie director, newspapers and books of that era, and the like in consideration of its genre and production year.

Similarly, in the case of preparations for foreign language classes, the recommended content may be configured to contain related books, etc. in addition to “foreign language textbooks” used in those classes.

Furthermore, the recommended content may be configured to be decided on the basis of the remaining viewing time (remaining time) of content viewed by a learner halfway. More specifically, if the remaining time is 45 minutes, the recommended content may be selected from a group of types of content whose viewing ends in 45 minutes.

The information processing device 100 according to the present embodiment may be configured, for example, such that a learner can conduct language study according to the most recent learning level, in consideration of the case in which the learner wants to view the same content repeatedly. More specifically, at the timing when the correct answer rate exceeds a predetermined threshold value, learning vocabulary thereafter may be changed according to the most recent learning level, without changing content viewed by a learner. As a result, learning effects can be enhanced even when a learner views the same content he/she likes repeatedly.

The control unit 113 may also establish a learning schedule for a learner using the correct answer rate, which is an indicator showing learning effects, and an approximate value of a forgetting curve.

The forgetting curve refers to a curve obtained using an experimental and statistic method to show how much a subject can recollect a certain widely-known thing over time after memorizing it. For example, a learner sometimes forgets learning vocabulary having a relatively high correct answer rate after a lapse of time. Therefore, a forgetting curve (forgetting timing) according to learning history may be established for each learner, and then a learning schedule for urging a learner to relearn (review) it may be established on the basis of this forgetting timing.

The configuration may also be such that a learning schedule may be established using a recommendation function that presents optimum content (e.g., content having the vocabulary at relatively many places) comprising vocabulary a learner might likely forget as recommended content. The established learning schedule is recorded in the user skill recording unit 108. The learning schedule is controlled by the main control unit 113 such that it is output to the output unit 112 at the request of a learner, or the timing of starting learning is output to the output unit 112 as an alert.

The main control unit 113 may also perform control such that the output of content is started only after learning vocabulary stored in the storage unit 105 is displayed on the display screen as characters (or videos) or is output from a speaker as voices. As a result, a learner is urged to learn learning vocabulary even before viewing content. The configuration may also be such that the viewing of content can be started after all of the specified learning vocabulary is output or after only part of the learning vocabulary is output.

The input unit 111 and the output unit 112 may be linked to a mobile information terminal (e.g., smartphone, tablet PC) or the like that is bidirectionally communicable to the information processing device 100. This is described in detail blow as a variation.

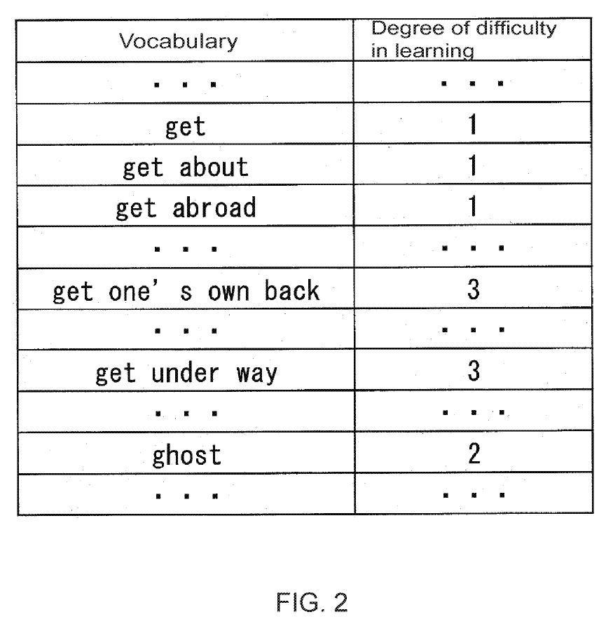

FIG. 2 is a view showing one example of vocabulary in a language to be learned that is stored in the dictionary DB 101.

As shown in FIG. 2, the configuration comprises vocabulary and the level of difficulty in learning. In the section “vocabulary,” vocabularies such as words, idioms or phrases are stored. In the section “the level of difficulty in learning,” information about the level of difficulty associated with each vocabulary is stored.

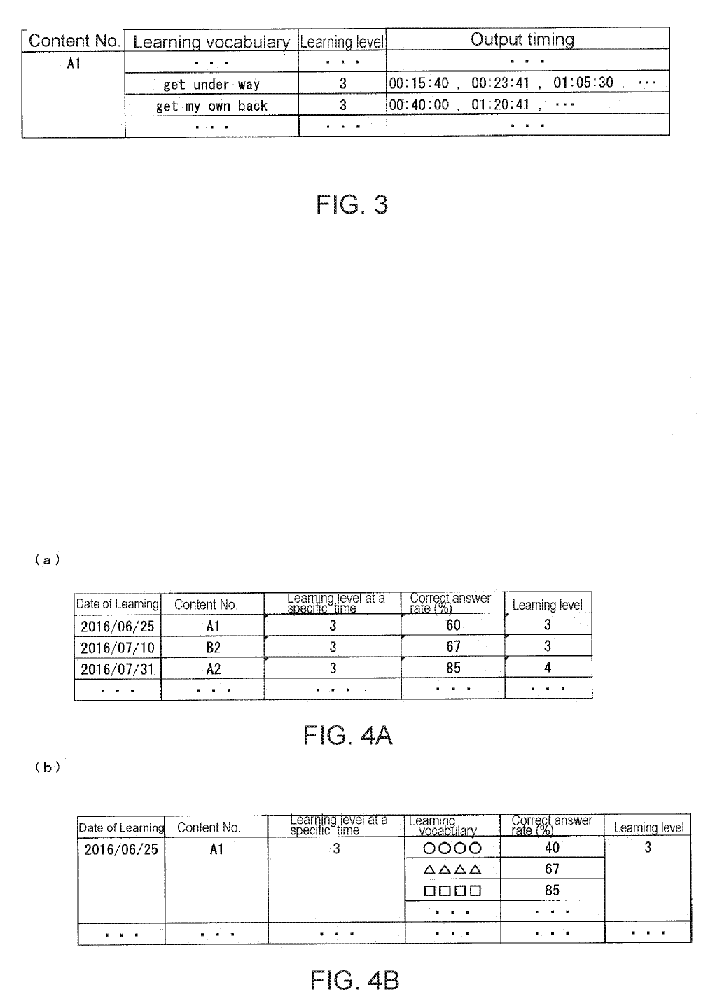

FIG. 3 is a view showing one example of learning vocabulary stored in the storage unit 105.

As shown in FIG. 3, learning vocabulary comprises content no, learning vocabulary, learning level and output timing.

In the section “content no,” information used for uniquely specifying content is stored. The word “A” in content A1 shows that the content is classified in the category of action. In the section “learning vocabulary,” learning vocabulary specified by the specification unit 106 is stored. Such information is extracted when vocabulary in a language to be learned is extracted by the extraction unit 103, if category information (genre information) is included in content. If such information is not included, a learner will input the category information via the input unit 111 at a time when content is selected.

In the section “learning level,” the learning level at the time of specifying learning vocabulary is stored. In the “output timing,” the output timing of learning vocabulary at the time of reproducing content is stored. For example, the section of the learning vocabulary “get under way” shows that the learning vocabulary is output at the timing of 15 minutes 40 seconds, 23 minutes 41 seconds, and 1 hour 5 minutes 30 seconds after starting the reproduction of content.

FIGS. 4A and 4B are views showing one example of learning history recorded in the user skill recording unit 108.

The learning history shown in FIG. 4A comprises date of learning, content no, learning level at a specific time, correct answer rate (%), and learning level. The learning history shown in FIG. 4B comprises the section of learning vocabulary in addition to all sections shown in FIG. 4A.

In the section “date of learning” shown in FIG. 4A, date (day and time) on which a learner learned something is stored. In the section “content no,” information used for uniquely specifying content is stored. For example, content A1 and content A2 show that both are classified in the same category of action but have different content. Content B2 is shown to be content classified in the category of current events (e.g., new footage), for example.

In the section “learning level at a specific time,” the learning level at a time when learning vocabulary was specified is stored. In the section “correct answer rate (%),” the correct answer rate for each viewing of content is stored. In the section “learning level,” the learning level changed on the basis of the correct answer rate (%) is stored.

Change in the learning level may be pre-set: for example, if the correct answer rate (%) is kept at a low level (e.g., 40 (%)), the learning level is brought down by one level; or if the correct answer rate (%) exceeds 90(%), the learning level is brought up by one level at that point in time.

The learning level at the time of specifying learning vocabulary may be pre-set such that the learning level on the most recent date of learning is adopted, or such that the most recent learning level corresponding to the category of content selected by a learner is adopted.

In the section “learning vocabulary” shown in FIG. 4B, learning vocabulary is stored for each category specified by the specification unit 106. In the section “correct answer rate” shown in FIG. 4B, the correct answer rate (%) for each learning vocabulary is stored. In this case, the learning level to be stored in the section “learning level” is a learning level changed on the basis of an average value of correct answer rates (%) for all learning vocabularies.

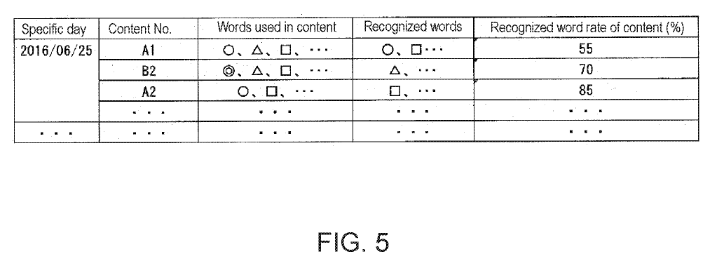

FIG. 5 is a view showing one example of recognized word rates of content recorded in the user skill recording unit 108.

The recognized word rate of content shown in FIG. 5 comprises specified day, content no, words used in content, recognized words, recognized word rate of content (%), and learning level. Such information is correlated to each learner.

In the section “specified day” shown in FIG. 5, the date on which the recognized word rate of content was specified is stored. The recognized word rate of content changes in its value on the basis of the learning level, which in turn changes according to the learning history of a learner, as described above, and therefore its specified day is recorded.

In the section “content no,” information used for uniquely specifying content is stored. For example, content A1 and content A2 show that both are classified in the same category of action but have different content. Content B2 is shown to be content classified in the category of current events (e.g., new footage), for example.

In the section “words used in content,” vocabulary extracted, for each content, by the extraction unit 103 in a language to be learned used therein is stored as information.

In the section “recognized words,” vocabulary already understood by a learner, which was specified on the basis of the determination result obtained by the determination unit 107, is stored.

In the section “recognized word rate of content,” information showing an estimated value of the level of understanding for each content, which was specified on the basis of words used in the content and recognized words, is stored. The estimate value showing the level of understanding is specified by the main control unit 113 that the level of understanding of a learner for content no. A1 at a certain point in time is 55(%), for example, and the specified result is stored.

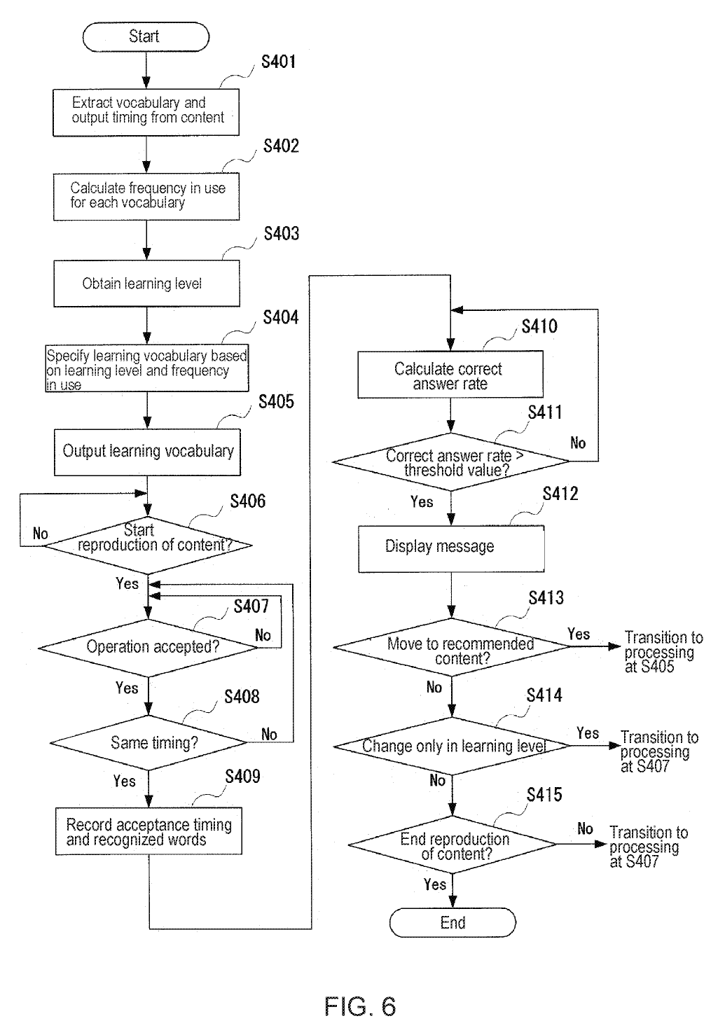

FIG. 6 is a flowchart showing one example of the processing procedure of the information processing device 100.

Each process described below can be achieved by the main control unit 113 and each functional unit of the information processing device 100 working together. The following describes the case in which the correct answer rate is found for each learning vocabulary in content selected and viewed by a learner from among a plurality of types of content. Moreover, the following describes that input operation is performed (e.g., a key is pressed) when a leaner understood what the learning vocabulary “get under way” was said, for example, while content has been reproduced.

The main control unit 113 extracts vocabulary in a language to be learned used in content and its output timing (S401). The main control unit 113 calculates the frequency in use of vocabulary extracted by the extraction unit 103 for each vocabulary (S402). The extraction result and the calculation result are stored in a predetermined area of the storage unit 105, for example.

The main control unit 113 obtains a learning level from the user skill recording unit 108 (S403) and specifies a learning vocabulary from among vocabularies extracted by the extraction unit 103, on the basis of the learning level and the frequency in use (S404). The specified learning vocabulary is stored in the storage unit 105 after it is associated with its output timing. The abovementioned process should be performed for a plurality of types of content in advance in consideration of a plurality of learning levels in order to accommodate the selection of content by a learner at will and the presentation of recommended content.

The main control unit 113 outputs the learning vocabulary specified by the specification unit 106 to the output unit 112 (S405). After S405 is processed, the main control unit 113 determines whether or not the output of content (reproduction of content) should be started on the basis of whether or not predetermined conditions have been satisfied (S406). As used herein, the satisfaction of predetermined conditions refers to the case in which after completing the output of the learning vocabulary to the output unit 112, time required for learning by a learner (e.g., 10 minutes) has passed, for example. The control may also be such that the output of content can be started when the instructions of end of learning given by a learner were accepted.

The main control unit 113 proceeds with the process at S407 when the predetermined conditions were satisfied and the output of content was started (S406: Yes). If it is not so (S406: No), the process is not proceeded until the predetermined conditions are satisfied.

The main control unit 113 detects the acceptance of input operation from the learner while content has been output. When the acceptance of input operation from the learner was detected (S407), the main control unit 113 determines, via the determination unit 107, whether or not the acceptance of input operation and the output timing of learning vocabulary have occurred at the same timing (S408). When the determination unit 107 determines that the timing was the same (S408: Yes), the main control unit 113 records the acceptance timing of input operation, and also records the learning vocabulary “get under way” in the user skill recording unit 108 as recognized words (S409). It is desirable for a learner to increase the number of recognized words each time of learning. There might be an occasion when a learner understands what was said but does not understand the meaning of the vocabulary. Therefore, if the acceptance timing of input operation and the output timing of learning vocabulary have not occurred at the same timing, it can be determined that the vocabulary is an unclear vocabulary, which the learner has not learned yet with respect to the output of the learning vocabulary, or the vocabulary for which a learner performed input operation may be regarded as an unclear vocabulary. The following describes this point.

The configuration may be such that if the process of registering recognized words of a learner is mainly performed, the acceptance of input operation from a learner is recorded as an input operation for specifying an unclear vocabulary that the learner has not learned yet with respect to the output of learning vocabulary after associating the input operation with the unclear vocabulary, and that learning vocabulary contained in the content other than the unclear vocabulary is recorded in the user skill recording unit 108 as recognized words of a learner (first information).

In this case, the configuration may be such that before a learner starts learning, the input operation of learning may be optionally switched between one showing the understanding of learning vocabulary and one showing an unclear vocabulary. Alternatively, both ways may be accommodated without switching therebetween, if they are associated with a pattern of input operation (e.g., a single tap is used when the understanding of recognized words is shown, while a double tap is used when an unclear vocabulary is shown).

As we return to the explanation of FIG. 6, the main control unit 113 checks the output timing of learning vocabulary against the recorded acceptance timing of input operation to calculate a correct answer rate for each learning vocabulary (S410).

The main control unit 113 determines whether or not the correct answer rate for each learning vocabulary has exceeded a predetermined threshold value (e.g., the correct answer rate is 90(%)) (S411). Here, whether or not a predetermined threshold value has been exceeded may be determined by making a comparison with the correct answer rate of a specific learning vocabulary or by making a comparison with an average correct answer rate for each learning vocabulary.

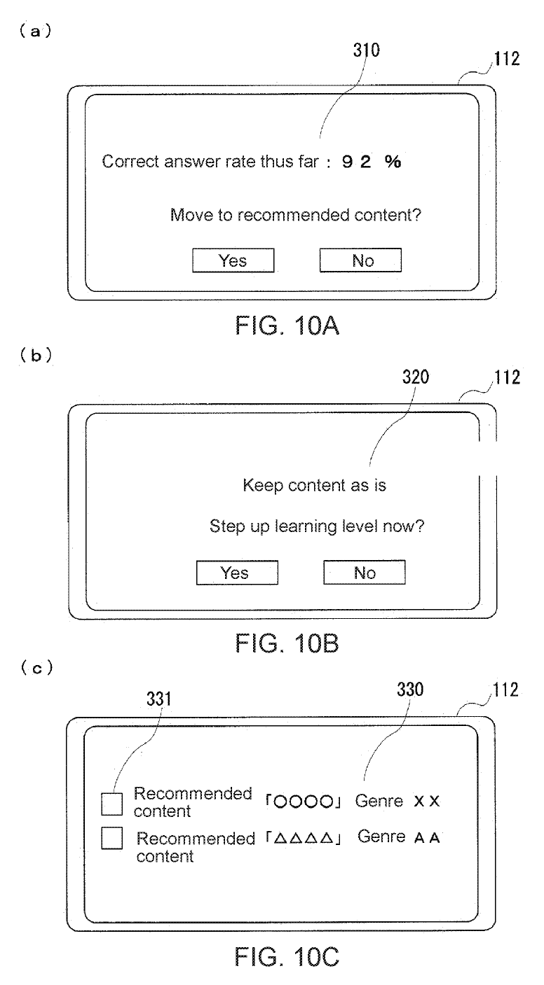

When it is determined that a predetermined threshold value has been exceeded (S411: Yes), the main control unit 113 displays a message for recommended content (S412). The message presented to a learner will be described below in FIG. 10.

The main control unit 113 determines whether or not the learner has selected to move to the recommended content (S413). If it is determined that the learner has selected to move to the recommended content (S413: Yes), the process is proceeded to S405. Thus, learning is started in which the recommended content is learning content.

If it is not so (S413: No), the main control unit 113 determines whether or not the learner has selected to change learning vocabulary to one corresponding to the most recent learning level without changing the learning content (S414). If it is determined that selection was made to change the learning level (S414: Yes), the process is proceeded to S407.

In this manner, the learner performs new learning corresponding to the most recent correct answer rate without changing the learning content. The control may also be performed such that before starting this language study, learning vocabulary corresponding to the most recent learning level is output, and then learning can be started, as shown in the process at S405.

The main control unit 113 determines whether or not the output of content (reproduction of content) is ended (S415). More specifically, it is determined that the output of content is ended when a signal indicating the end of output (i.e., all of the content is output) is detected (S415: Yes). Thus, a series of processes comes to an end.

The main control unit 113 can also perform control such that information corresponding to the result of the most recent process at S410 is output to the output unit 112. The information corresponding to the result of the process at S410 refers to the final correct answer rate for the present learning, for example. In this case, the learner can confirm the final result of the present learning including the process after transiting to the recommended content or after changing the learning level during the viewing period. Moreover, the registration unit 102 may change the learning level according to the correct answer rate calculated by the process at S410.

For example, if the final correct answer rate exceeds 80(%), the learning level is brought up by one level. The learning level after the change is registered in the user skill recording unit 108.

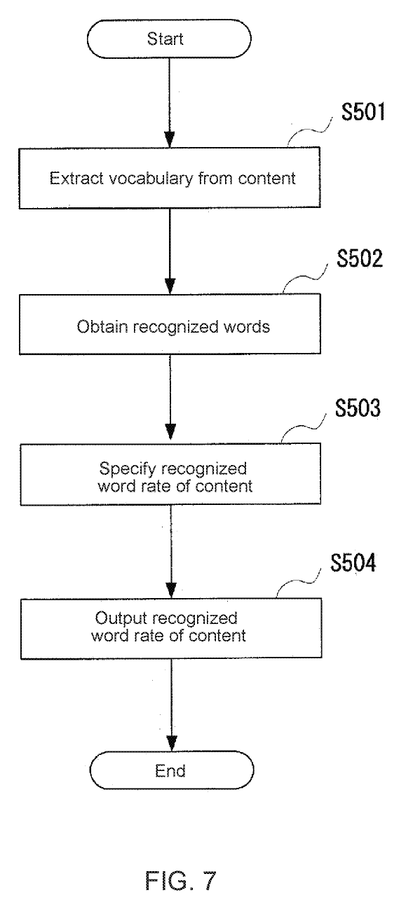

FIG. 7 is a flowchart showing one example of processing procedures in which a recognized word rate of content is specified and displayed on a display screen.

Each process described below can be achieved by the main control unit 113 and each functional unit of the information processing device 100 working together.

The main control unit 113 extracts, for each content, vocabulary in a language to be learned used therein (S501). The extraction result is stored in the storage unit 105 after associating it with content.

The main control unit 113 obtains the recognized words of a learner recorded in the user skill recording unit 108 (S502).

The main control unit 113 specifies, for each content, the recognized word rate of content via the specification unit 106 on the basis of words used in content and recognized words (S503). The specified result is recorded, for each content, in the user skill recording unit 108 together with date (day and time) after associating them with learners and content.

The main control unit 113 outputs the recognized word rate of content onto the display device (S504). Thus, a series of processes comes to an end.

Thus, the main control unit 113 serves as a control unit for performing control such that a selected content for a learner is output (reproduction, etc.) as the learning content on the basis of the presented recognized word rate of content.

A series of processes from S501 up to S504 may be configured such that the process is stared at optional timing according to instructions given by a learner, or that the process is started at the timing when the learning level is changed.

The configuration may also be such that after starting learning using a content selected by a learner on the basis of the recognized word rate of the content as a learning content, transition to recommended content may be recommended at the timing when predetermined conditions are met.

Accordingly, a learner can select the content that matches his/her level of understanding as a learning content from among a plurality of different contents on the basis of the recognized word rate of content, which changes according to the progress of learning, or select any content that fits the learning style suitable for his/her feelings at a specific time. In other words, a learner can freely change his/her learning style on the basis of his/her feelings at a specific time.

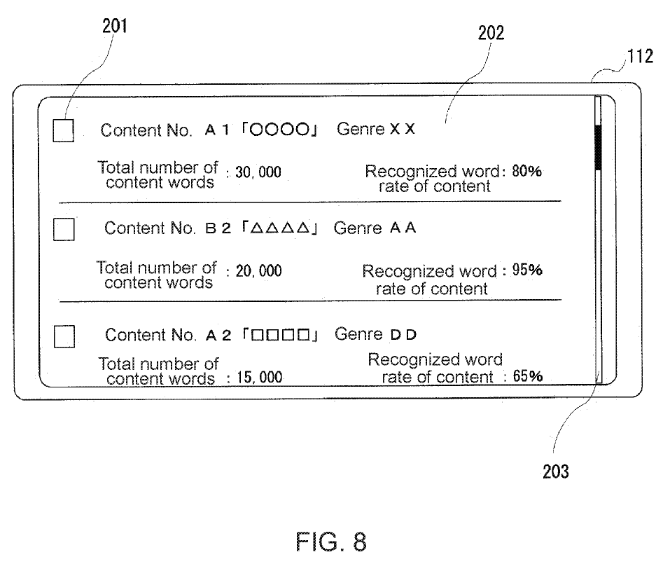

FIG. 8 is a schematic view of an exemplary screen display when information about a recognized word rate of content is presented to a learner.

FIG. 8 shows, on the screen of the output unit 112, which is a display device, a selection button 201, and on a display area 202 a content no., the total number of words in the content and the recognized word rate of the content. Any information that has not been displayed on the display screen yet can be confirmed on the screen by operating a scroll 203. A learner selects content via the selection button 201 with reference to such information displayed on the display screen.

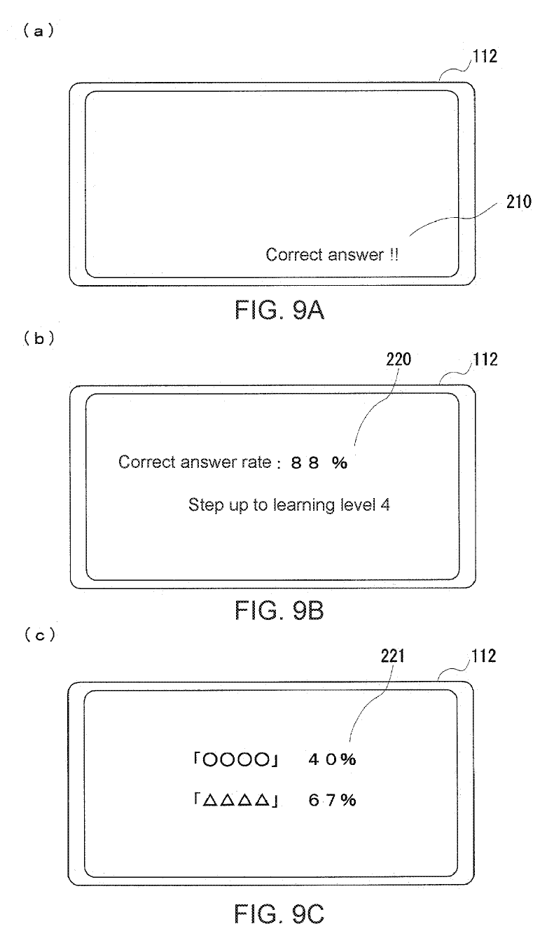

FIG. 9 shows schematic views of an exemplary screen display when information used for confirming learning effects is presented to a learner. FIG. 9A shows the display of “Correct Answer! !” on the screen of the output unit 112, which is a display device, for example. The information 210 shown in FIG. 9A is information displayed when the determination unit 107 has determined that the output timing of learning vocabulary and the acceptance timing of input operation occurred at the same timing.

FIG. 9B displays the correct answer rate resulted from the current learning and a learning level (220) obtained on the basis of the result. The information 220 shown in FIG. 9B displays “correct answer rate: 88%,” and “step up to learning level 4.”

FIG. 9C displays learning vocabularies with lower correct answer rates in the current learning, together with their correct answer rates. The information 221 shown in FIG. 9C displays that the correct answer rate of a learning vocabulary “OOOO” was “40%” and the correct answer rate of a learning vocabulary “Δ Δ Δ Δ” was “67%.”

The presentation of such various types of information allows a learner to visually confirm the effect of the current learning and recognize vocabulary that should be reviewed. Such information may also be presented to a learner phonetically.

FIG. 10 shows schematic views of an exemplary screen display when information about recommended content is presented to a learner.

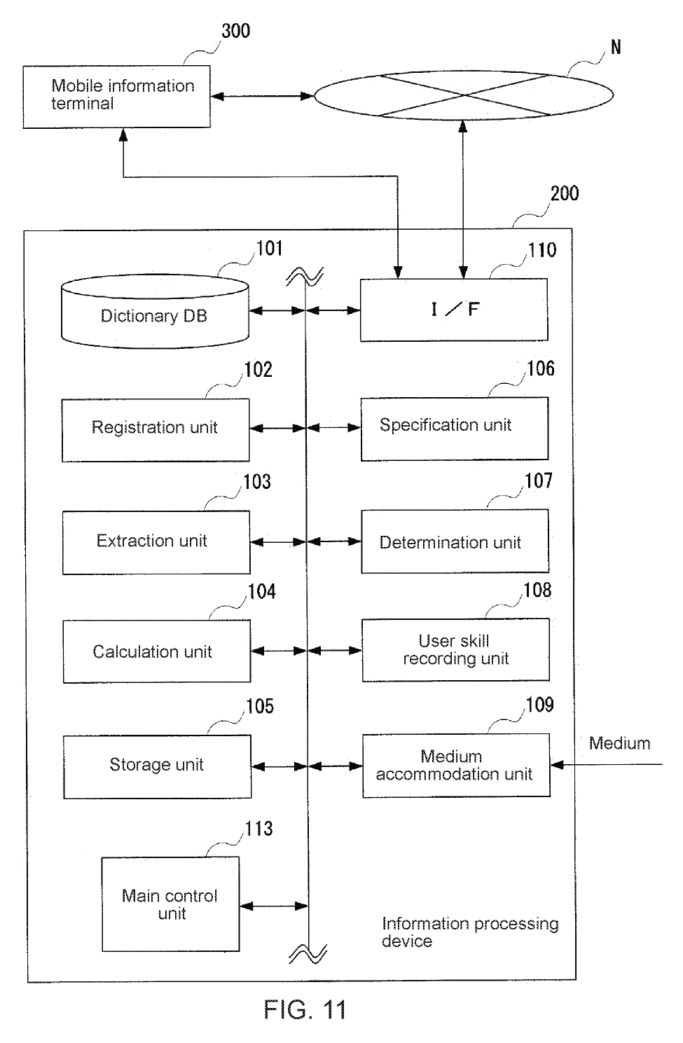

FIG. 10A shows one example of messages relating to recommended content displayed on the screen of the output unit 112. The information 310 shown in FIG. 11A is information that is shown, for each vocabulary, when the correct answer rate has exceeded a predetermined threshold value (e.g., the correct answer rate: 90(%)) and is showing that the current correct answer rate is 92(%) and that whether or not a learner wants to move to recommended content can be selected by using a selection button “Yes” or “No.” If the learner selects “Yes,” the language study is transferred to the recommended content.

FIG. 10B shows one example of information displayed on the screen of the output unit 112 when the learner selected “No” in FIG. 11A. In the information 320 shown in FIG. 10B, the learner makes a selection as to whether or not the currently-viewed content should be kept as is and learning vocabulary thereafter should be changed according to the most recent learning level. If the learner selects “Yes,” the learner is moved to language study in which learning vocabulary thereafter is changed to one corresponding to the most recent learning level.

FIG. 10C shows one example of information that is configured as follows: if a plurality of types of content are specified as recommended content, such information is presented so that a learner can make a selection. The information 330 is configured such that a learner can select either recommended content “OOOO” of a genre “XX” or recommended content “Δ Δ Δ Δ” of a genre “AA” via a selection button 331.

The presentation of information about recommended content may also be established at the timing when viewing of content by a learner has come to an end.

Thus, the information processing device 100 according to the present embodiment presents an estimated value of the level of understanding (i.e., the recognized word rate of content) for each content, and therefore the learner can freely select content according to the learning style on the basis of his/her feelings at a specific time.

Consequently, the degree of freedom of selecting content increases; therefore, when a learner wants to study a language in a learning style of just listening, the learner can select content of a genre which he/she takes an interest, even though the recognized word rate of presented content is low for him/her, or when the learner wants to confirm learning effects, he/she can select content in which the recognized word rate of presented content is substantially 100(%) for him/her. Hence, a learner can study a language by freely changing the learning style on the basis of his/her feelings at a specific time, without losing his/her motivation for learning.

Moreover, the information processing device 100 specifies learning vocabulary in decreasing order of frequency in use, on the basis of the learning level of a learner and the frequency in use of vocabulary used in content. Moreover, the correct answer rate can be found by recording input operation accepted while content has been output as an input operation with respect to the output of learning vocabulary. Furthermore, information about recommended content is presented at appropriate timing according to the correct answer rate.

As a result, a learner can study a language effectively according to his/her own learning level at a specific time. Moreover, a learner can learn phrases characteristic of content according to the learning level of the learner. Therefore, the learner can not only enjoy viewing content but focus on language study as well, and therefore his/her motivation for learning enhances and the learning effect increases.

In the abovementioned example, the recognized word rate of content is specified from the percentage of recognized words as compared with the extraction result of vocabulary in a language to be learned used in the content, which was extracted, for each content, by the extraction unit 103. Alternatively, the information processing device 100 may also be configured such that the recognized word rate of content is specified from a value obtained by estimating the percentage of recognized words as compared with learning vocabulary specified by the specification unit 106.

In this case, the specification unit 106 specifies vocabulary from among vocabularies in a language to be learned used in content as a learning vocabulary, on the basis of a registered learning level and a frequency in use, and then specifies the level of understanding of content of a learner as the recognized word rate of content (second information), on the basis of the abovementioned learning vocabulary and recognized words.

Thus, the level of understanding of vocabulary specified on the basis of the learning level of a learner is presented for vocabulary in a language to be learned used in content, so that the learner can select content with higher efficiency when he/she wants to confirm learning effects, for example.

The main control unit 113 records recognized words of a learner at S409, wherein the configuration may also be such that learning vocabulary determined by the determination unit 107 that timing was the same consecutively for a predetermined number of times (e.g., five times) can be recorded in the user skill recording unit 108 as recognized words understood by the learner.

Thus, words correctly answered accidentally cannot be recorded as recognized words; therefore recognized words of a learner can be recorded more accurately, and the accuracy of the recognized word rate of content can be increased.

### (Variation)

FIG. 11 is a view showing an exemplary composition of an information processing device when it is linked to a mobile information terminal. Here, the same reference numerals are used for parts that are the same for parts described above, and the description of those parts will be omitted.

The information processing device 200 is constituted of a dictionary DB (database) 101, a registration unit 102, an extraction unit 103, a calculation unit 104, a storage unit 105, a specification unit 106, a determination unit 107, a user skill recording unit 108, a medium accommodation unit 109, an 1/F (interface) 110, an input unit 111, an output unit 112, and a main control unit 113. This configuration is different from the abovementioned information processing device 100 in that the input unit 111 and the output unit 112 are not used.

A mobile information terminal 300 is, for example, a smartphone, a tablet PC, or a portable PC and comprises an operation button that serves as an input unit (not shown here), a display device that serves as an output unit (not shown here), and a control unit (not shown here) for controlling those and other component devices.

The mobile information terminal 300 is communicably configured using the Internet line N or wireless communication (e.g., Wi-Fi), or wired communication, so that various types of information can be exchanged with the information processing device 200. In this case, the information processing device 200 serves as a server device for transmitting various types of information to the mobile information terminal 300 or receiving various types of information from the mobile information terminal 300. Thus, the mobile information terminal 300 serves as a kind of computer.

Also, functions characteristic of the present invention can be achieved by installing computer programs of the present invention in the mobile information terminal 300. In this case, a learner can conduct language study using only the mobile information terminal 300.

The configuration may also be such that the input unit of the mobile information terminal 300 is used as the input unit 111 and the output unit of the mobile information terminal 300 as the output unit 112. As a result, as long as information can be exchanged with the information processing device 200, a learner can conduct language study using the mobile information terminal 300, without being restricted by the learning place.

The abovementioned embodiments were used solely for the purpose of describing the present invention specifically; therefore the scope of the present invention is not limited by those embodiments.

Furthermore, the present invention may also be a method comprising the abovementioned processing procedures performed by the information processing device.

Furthermore, the present invention may also be a computer program for allowing a computer to execute the abovementioned processing procedures performed by the information processing device.

The computer program is one that can be distributed via various recording media or networks. The computer program becomes executable and realizes the abovementioned information processing device when it is installed in a computer with a memory device such as ROM.

### EXPLANATION OF REFERENCE NUMERALS

100, 200: Information processing device
101: Dictionary DB
102: Registration unit
103: Extraction unit
104: Calculation unit
105: Storage unit
106: Specification unit
107: Determination unit
108: User skill recording unit
109: Medium accommodation unit
110: I/F
111: Input unit
112: Output unit
113: Main control unit
300: Mobile information terminal
N: Internet line

1. An information processing device for outputting a content created in a language to be learned as a learning content, comprising:
an extraction unit for extracting, for each content, vocabulary used in one or each of a plurality of contents and comprising words, idioms or phrases in the language to be learned, wherein each of the phrases comprise a plurality of words;
a recording unit for recording vocabulary learned by a learner as first information;
a specification unit for specifying a level of understanding of the content of the learner as second information based on an extracted result obtained by the extraction unit and the first information recorded by the recording unit;
a presentation unit for presenting the specified second information to the learner; and
a control unit for controlling such that a selected content based on the presented second information is output as the learning content.

2. The information processing device according to claim 1, further comprising:
a registration unit for registering a learning status of the learner in the language to be learned as a learning level; and
a calculation unit for calculating the number of uses of vocabulary in the language to be learned used in the content as frequency in use,
wherein the specification unit specifies a vocabulary to be learned as a learning vocabulary from among vocabulary in the language to be learned used in the content, based on the registered learning level and the calculated frequency in use, and specifies the level of understanding of the content of the learner as second information based on the learning vocabulary and the first information recorded by the recording unit.

3. The information processing device according to claim 2, further comprising an acceptance unit for accepting an input operation, wherein the control unit records the input operation accepted by the acceptance unit while the content has been output in the recording unit as an input operation for the output of the leaning vocabulary; makes a comparison between the number of outputs of the learning vocabulary and the number of acceptances of the input operation; makes the learning vocabulary a vocabulary learned by the learner according to the comparison result; and performs control such that the vocabulary is recorded as first information.

4. The information processing device according to claim 3, wherein the registration unit changes the registered learning level according to the number of the recorded input operations, and the control unit performs control such that the output learning content is output after it is switched to a learning content according to the learning level after the change.

5. The information processing device according to claim 3, comprising:
a storage unit for storing an output timing and a leaning vocabulary after associating them with each other, wherein the timing when the learning vocabulary specified in the specification unit is used in the content is set as the output timing; and
a determination unit for determining whether or not the output timing of the learning vocabulary and a timing of the input operation accepted by the acceptance unit have occurred at the same timing, wherein when it is determined that the timing is the same by the determination unit, the control unit makes the learning vocabulary a vocabulary learned by the learner and controls such that the vocabulary is recorded as first information.

6. The information processing device according to claim 5, wherein when it is determined by the determination unit that the timing is the same, the registration unit records the input operation as an input operation for the output of the learning vocabulary and changes the registered learning level according to the number of the recorded input operations, and the control unit performs control such that the learning content is output after it is switched to a learning content according to the learning level after the change.

7. The information processing device according to claim 4, wherein when the learning level after the change exceeds a predetermined threshold value, the control unit performs control such that the presentation unit outputs information that recommends a learning content according to the learning level after the change.

8. The information processing device according to claim 4, wherein when the learning level after the change exceeds a predetermined threshold value, the control unit performs control such that learning vocabulary according to the learning level after the change is output without changing the output learning content.

9. The information processing device according to claim 3, wherein the control unit records an input operation accepted by the acceptance unit while the content has been output in the recording unit as an input operation for an unclear vocabulary that the learner has not learned yet with respect to the output of the learning vocabulary and performs control such that learning vocabulary contained in the content other than the unclear vocabulary is recorded in the recording unit as first information.

10. A method for controlling an information processing device that outputs content created in a language to be learned as a learning content, the method comprising:
a step of extracting, for each content, vocabulary used in one or each of a plurality of contents and comprising words, idioms or phrases in the language to be learned, wherein each of the phrases comprise a plurality of words;
a step of recording vocabulary learned by a learner as first information;
a step of specifying a level of understanding of the content of the learner as second information based on an extraction result and the recorded first information;
a step of presenting the specified second information to the learner; and
a step of performing control such that a selected content based on the presented second information is output as the learning content.

11. A computer program for allowing a computer to serve as an information processing device for outputting a content created in a language to be learned as a learning content, the computer program allows the computer to serve as the following:
an extraction unit for extracting, for each content, vocabulary used in one or each of a plurality of contents and comprising words, idioms or phrases in the language to be learned, wherein each of the phrases comprise a plurality of words;
a recording unit for recording vocabulary learned by a learner as first information;
a specification unit for specifying a level of understanding of the content of the learner as second information based on an extraction result and the first information recorded by the recording unit;
a presentation unit for presenting the specified second information to the learner; and
a control unit for performing control such that a selected content based on the presented second information is output as the learning content.

12. An information processing device that is configured to be communicable with a mobile information terminal provided with an input unit for accepting input operation and outputs content created in a language to be learned to the mobile information terminal as a learning content, the device comprising:
an extraction unit for extracting, for each content, vocabulary used in one or each of a plurality of contents and comprising words, idioms or phrases in the language to be learned, wherein each of the phrases comprise a plurality of words;
a recording unit for recording vocabulary learned by a learner as first information;
a specification unit for specifying a level of understanding of the content of the learner as second information based on an extraction result and the first information recorded by the recording unit;
a presentation unit for presenting the specified second information to the learner; and
a control unit for performing control such that a selected content based on the presented second information is output as the learning content.

13. The information processing device according to claim 6, wherein when the learning level after the change exceeds a predetermined threshold value, the control unit performs control such that the presentation unit outputs information that recommends a learning content according to the learning level after the change.

14. The information processing device according to claim 6, wherein when the learning level after the change exceeds a predetermined threshold value, the control unit performs control such that learning vocabulary according to the learning level after the change is output without changing the output learning content.

15. The information processing device according to claim 4, wherein the control unit records an input operation accepted by the acceptance unit while the content has been output in the recording unit as an input operation for an unclear vocabulary that the learner has not learned yet with respect to the output of the learning vocabulary and performs control such that learning vocabulary contained in the content other than the unclear vocabulary is recorded in the recording unit as first information.
